(19) United States
(12) Patent Application Publication
(10) Pub. No.: US 2021/0069590 A1
(43) Pub. Date: Mar. 11, 2021

(54) METHOD FOR PLAYING BACK APPLICATIONS FROM A CLOUD, TELECOMMUNICATION NETWORK FOR STREAMING AND FOR REPLAYING APPLICATIONS (APPS) VIA A SPECIFIC TELECOMMUNICATION SYSTEM, AND USE OF A TELECOMMUNICATION NETWORK FOR STREAMING AND REPLAYING APPLICATIONS (APPS)

(71) Applicant: GORILLABOX GmbH, HAMBURG (DE)

(72) Inventors: Frederik PETER, Hamburg (DE); Sheikh KHALIL, Hayes (GB); Remco WESTERMANN, Dusseldorf (DE)

(73) Assignee: GORILLABOX GmbH, HAMBURG (DE)

(21) Appl. No.: 17/000,878

(22) Filed: Aug. 24, 2020

Related U.S. Application Data
(63) Continuation-in-part of application No. 15/746,496, filed on Jan. 22, 2018, now abandoned.

(51) Int. Cl. A63F 13/493; H04L 29/06; H04L 29/08; H04L 1/18; A63F 13/355

(52) U.S. Cl. CPC A63F 13/493; H04L 65/1069; H04L 65/1003; A63F 13/355; H04L 67/38; H04L 1/1809; H04L 67/1002

(57) ABSTRACT

The invention relates to a method for streaming and reproducing applications (APPs) via a particular telecommunication system and a telecommunication network and also the use of a telecommunication network for streaming and reproducing such applications (APPs). The method according to the invention allows non-natively programmed applications to be played back on non-software-native environments, specifically without meeting the hardware-specific prerequisites of the non-native platforms, for example in respect of computer and graphics power, and without meeting the software-specific prerequisites of the non-native platforms, for example applications that run only via one particular operating system.

### CROSS-REFERENCE TO RELATED APPLICATIONS

This application is a Continuation-In-Part of U.S. patent application Ser. No. 15/746,496, filed on Jan. 22, 2018, now pending, which is a 35 U.S.C. § 371 U.S. National Phase of International Application No. PCT/EP2015/001535, filed Jul. 24, 2015, which is hereby incorporated by reference in its entirety.

### DESCRIPTION GENRE

The invention relates to a method for streaming and reproducing applications (APPs). Moreover, the invention relates to a telecommunication network for streaming and reproducing applications (APPs). Finally, the invention also relates to the use of a telecommunication network.

### PRIOR ART

Today, it is more and more important to develop applications natively. Native developments are always individually adapted to one particular platform, however. The problem, however, is that newer and more modern platforms are always entering the market and users use not only one platform but rather many different platforms.

A further problem is the underlying hardware. Specific applications also form the basis of specific hardware. This hardware has to meet particular demands on the application, for example graphics load, processor capacity, memory, energy consumption. Conversely, however, an application can also use more computer power or graphics power than the hardware of the platform can provide. Specifically in the case of graphics-intensive applications—for example games—this can lead to users being unable to use them, since the system is incompatible. There are fundamentally three different approaches to transferring applications to a platform-non-native environment.

First, there is what is known as the native development (porting). The application is redeveloped from the standpoint of the non-native platform. Of all three methods, this is the most complex and most time-consuming way, but it affords the opportunity to use all the functionalities of the new platform. One problem of this method, however, is that the application is subject to the constraints of the platform. As such, it is not possible for games with high graphics demands to be ported to a mobile platform, for example. Different hardware prerequisites within the non-native platform are also a problem, since not every user has the same mobile radio, for example.

Additionally, there is already software in existence that is intended to allow the developer to make a native development easier. Porting takes place using particular software to the effect that portions of the existing software are replaced so as to achieve compatibility with the non-native system. This step is not always possible, since some platforms differ architectonically from one another too much. In such cases, there is for the most part also a lack of support from the operator of the platform, and for this reason the native development is resorted to for the most part. Web apps are applications that are developed as a basis for web browsers and can therefore be used on almost all platforms. To this end, a WCM (Webcontent Management) system is also often used. These applications can be reached only via a corresponding browser, however, which the platform has to provide. A disadvantage with this method is that not all applications can be ported using this method. It is necessary to use a browser that does not always ensure a native depiction of the application.

Streaming: this means that the application runs on a server and is only played back on the non-native platform by means of a client. This technology is currently restricted, however, to particular applications that are not time-critical (the keyword in this case is “latency”).

WO 2012/037170 A1 discloses the practice of transmitting the application code to the client in parallel with the stream in order to be able to terminate the stream as soon as the application is executable on the client, so that the application runs directly on the client so as to be able to save streaming resources. This may be worthwhile for consoles, for example, but is not possible in the event of hardware-specific prerequisites (limitations).

WO 2009/073830 describes a system that provides the user with access to a service on the basis of a “subscription fee”. In this case, the customer is allocated a particular streaming server for the period booked. However, the system of the present invention allocates the user a geographically optimum streaming server without a “subscription fee” being needed.

Additionally, WO 2010/141522 A1 uses a game server via which the streaming communication between client and streaming server sometimes takes place. Moreover, the functionalities of the interactive layer are mapped via the video source, which, for the present invention, is dealt with via a separate server in order to also provide third parties with access to advertising space, for example.

### Object

The invention is based on the object of providing a method for streaming and reproducing applications (APPs) via a particular telecommunication system and of playing back non-natively compatible applications on non-software-native environments.

### Way of Achieving the Object

a method for streaming and reproducing applications (APPs) via a particular telecommunication system, in which one or more streaming servers that can connect to one another by telecommunication execute the relevant application and that connect to the respective telecommunication terminal locally, the relevant telecommunication terminal retrieving the required application from a local server that provides the computer power for rendering and encoding the relevant application.

Advantage: the individual selection of a local streaming server reduces the latency between streaming server and client to a minimum, so that a greatest possible range with a greatest possible coverage is achieved while the method works in a resource-saving manner and does not provide the streaming server until it is needed.

In another exemplary embodiment, a method is provided for reproducing applications on non-application-native system environments that differ through either different hardware components or software components, wherein the streaming server undertakes the handling of the different applications and the rendering/encoding of the application and the audio and video signals thereof, the data being transmitted to the respective telecommunication terminal—mobile radio, tablet, laptop, PC, TV—and the transmission being performed by means of a modified h.254 protocol and the WAN being used as a transmission means for audio/video packets by UDP/TCP and the computer power being sourced by the relevant streaming server, wherein the packaged data are decoded only on the telecommunication terminal.

Advantage: the standardization of the communication allows an ideal route for communication between client and streaming server to be chosen independently of the application at any desired time.

In yet another exemplary embodiment, a method is provided for providing a platform-independent streaming technology that is programmed once and portable to any telecommunication terminals, in which the streaming of the individual applications, for example video games, is effected via a WAN, such that
a) a communication with the session server is performed by means of the telecommunication terminal (small applications);
b) a particular session for a particular final consumer is performed for the streaming server of the relevant application, for example a game, that is geographically closest to the telecommunication terminal;
c) session information is communicated to the telecommunication terminal and the streaming server by the relevant session server;
d) a direct connection is made between the telecommunication terminal and the streaming server of the relevant application, for example a video game;
e) setting up a direct connection between the telecommunication terminal and the relevant streaming server involves the following steps being initiated:
   i. recording of the audio/video data of the running application, for example a game, via the relevant streaming server on which the game runs;
   ii. compression of the audio/video data by high-quality hardware encoders;
   iii. transmission of the compressed audio/video data via WAN;
   iv. reception of the audio/video data on the part of the telecommunication terminal;
   v. decompression of the audio/video data;
   vi. visualization of the audio/video data on the telecommunication terminal (small);
   vii. recording the actions (inputs) of the user of the telecommunication terminal, for example a gamer, on the telecommunication terminal (small);
   viii. efficient transmission of the inputs back to the relevant streaming server of the game, and
   ix. reproduction of the transmitted inputs on the streaming server.

### Some Advantages

According to the stated object, the method according to the invention allows non-natively programmed applications to be played back on non-software-native environments, specifically without meeting the hardware-specific prerequisites of the non-native platforms, for example in respect of computer power and graphics power, and without meeting the software-specific prerequisites of the non-native platforms, for example applications that run only via one particular operating system. In comparison with for example US 2014/0073428 A1, the invention uses a client created specifically for this application. This client can be used on any desired platform in order to ensure almost latency-free reproduction of an h.254 compressed stream. For transferring the frames, the h.254 code is used. H.264/MPEG-4 AVC is an H. standard for high-efficiency video compression. The standard was adopted in 2003. The ITU designation for this is H.264. In the case of ISO/IEC MPEG, the standard goes by the designation MPEG-4/AVC (Advanced Video Coding) and is the tenth part of the MPEG-4 standard (MPEG-4/Part 10, IS O/IEC 14496-10).

The method according to the invention moreover involves resource handling being used that distributes the load to individual streaming servers in order to save first resources but second also capacities/investment. This allows the system to operate with greater cost savings than comparable systems as in the case of WO 2012/37170 A1, for example. This also affords the opportunity to shut down streaming servers during operation, for example in order to perform maintenance work. It is known generally that in almost all cases, as in WO 2010/141522 A1, for example, it is always necessary for what is known as a hook into the code of the application to be initiated in order to allow the streaming server to stream the application. This results in the application code needing to be altered, which can lead firstly to additional effort but secondly to considerable problems with the original developer of the application. The method according to the invention makes a hook superfluous and allows the method to be automated.

The client application fundamentally consists of three parts (decode thread, render thread and the interactive layer) and is recorded in clientnetwork.so (shared library). These parts break down into individual modules.

The client session manager module is responsible for managing (starting/ending) the session and is used to administer the session started by the user. This module can also be used to make settings with regard to latency optimization.

The network module undertakes the network communication and manages the communication with the streaming server.

The controller module intercepts the user input of the application and transmits the latter to the game streaming server.

The decoder render audio modules consists of two parts: the decoder module undertakes the decoding of the h.264 stream. The audio player plays the sound.

The evaluator module transmits reporting to the streaming server.

The recovery module undertakes the handling of the strategies for corrupt frames.

The client UI module is incorporated in the interactive layer and is responsible for the UI of the application.

The interactive layer allows an additional visual depiction of information to be visualized on the underlying render thread, for example in order to display community feature/assistance or advertising. It is above the render thread and can be individually adapted by the user.

For the interactive layer, a predefined user interface is provided for each platform. However, the user can use what is known as layer scripting to produce the applicable user interface, under particular constraints, himself. Layer scripting provides the user with a specifically developed scripting environment that allows particular functionalities to be tied to predefined buttons. It is thus possible for the user to adapt his UI individually to the needs thereof.

The streaming server fundamentally consists of three modules (network thread, GPU thread and session handler) and is recorded in servernetwork.dll (shared library). Each running application on the streaming server is respectively assigned a GPU and a network thread. This automatic process is managed by the session handler.

The network thread is responsible for delivery of the encoded audio and video file.

The GPU thread is responsible for the hardware encoding of the audio and video frames of the application, undertakes packet buffering via UDP/TCP and undertakes timestamping and compression.

The session handler is responsible for starting/stopping and managing the GPU & network threads. It coordinates available resources on the game streaming server and communicates with the session management server. The idea behind the session handler is automatic management of the resources in order to be able to save costs.

The session management server consists of four modules: authentication module; network module; session manager module; evaluator module.

The authentication of the client is undertaken by the access server in order first to store the client specifications for the streaming server in order to check whether the client is authorized to retrieve the requested application. The authentication can also work opposite a third-party system, so that non-native systems can also be coupled.

The network module is responsible for load balancing, quality assurance and administration. Load balancing is understood to mean the uniform distribution of the load within the network. In the quality assurance domain, every single stream is monitored and optimized on the basis of performance (for example by means of particular routing). The administration is intended to allow the administrator to inspect the present load and the routing in order to perform particular configurations.

The session manager module is responsible for load optimization and control of the game streaming servers. This unit links incoming client requests to a free slot on a game streaming server and then sets up a direct connection between client and streaming server. Critical criteria for a link are: latency between streaming server and application client and available resources. The aim is to use this unit to establish a resource-saving method in order to be able to shut down unused power.

Evaluator module. This undertakes generation of the statistics and administration.

The content server undertakes the display of advertising on the interactive layer of the applicable client for the appropriate game. Advertising can be displayed in multiple forms. There is either a permanent placement within the application or particular times are predefined that, as soon as they are initiated, set an appropriate trigger to display advertising.

UDP (User Datagram Protocol) is simple, less involved and more efficient for real time data transmissions. The problem with UDP, however, is that the is no mechanism for dealing with data packets that have been lost in the network. Therefore, screen errors, stutters and flickering occur while the game is played in the cloud.

We have determined four strategies that will intelligently correct the packet loss situation.

Blocking: strategy at the user end that involves a still being shown while error correction takes place. This will allow the user a better user experience in comparison with screen errors, stutters and flickering. This method will therefore ensure that the image is not erroneous in the event of packet loss.

Not blocking: strategy at the user end that involves no still being produced while a transmission of the lost packets is requested from the server. This fresh transmission is not comparable with the TCP transmission, since it is under our own control and we efficiently request it only when it is needed.

Intrarefresh: this strategy is implemented at the user end and speak to the video encoder (at the server end) in real time. In the event of the loss of a packet, it asks the encoder to perform a frame refresh. Therefore, as soon as it is interrupted on account of a loss of image packets, the image has a frame refresh applied to it in milliseconds, which the naked eye does not even notice.

Frame validation: this strategy keeps one eye on the frame rate at which images are sent from the server end. In the event of a fluctuating frame rate, it ensures that the image packets are sent at a constant frame rate. This helps to ensure a uniform image experience.

### Further Inventive Refinements

According to another embodiment of the present invention, in the event of packet loss during the transmission of files to the telecommunication terminal, for example from a gaming server to the telecommunication terminal, the following steps are performed:
a) recovery strategy is called on the telecommunication terminal (small) in order to maintain a smooth gaming experience;
b) the suitable recovery strategy is selected and
c) the recovery request is returned to the relevant streaming server of the application, for example the game.

Advantage: the automation of the recovery process reduces the duration of errors that occur by a multiple and thus allows an almost error-free, continuously self-calibrating transmission between streaming server and client.

### Way of Achieving the Object Relating to the Telecommunication Network

The present invention further discloses a telecommunication network for streaming and reproducing applications (APPs) via a particular telecommunication system, in which one or more streaming servers that can connect to one another by telecommunication execute the relevant application and that connect to the respective telecommunication terminal locally, the relevant telecommunication terminal retrieving the required application from a local server that provides the computer power for rendering and encoding the relevant application.

According to yet another embodiment, the present invention discloses a telecommunication network for reproducing applications on non-application-native system environments that differ through either different hardware components or software components, wherein the streaming server undertakes the handling of the different applications and the rendering/encoding of the application and the audio and video signals thereof, the data being transmitted to the respective telecommunication terminal—mobile radio, tablet, laptop, PC, TV—and the transmission being performed by means of a modified h.254 protocol and the WAN being used as a transmission means for audio/video packets by UDP/TCP and the complete computer power being undertaken by the relevant streaming server, wherein the packaged data are decoded only on the telecommunication terminal.

According to yet another embodiment, the present invention discloses a telecommunication network for providing a platform-independent streaming technology that is programmed once and portable to any telecommunication terminals, in which the streaming of the individual applications, for example video games, is effected via a WAN, such that
a) a communication with the session server is performed by means of the telecommunication terminal (small applications);
b) a particular session for a particular final consumer is performed for the streaming server of the relevant application, for example a game, that is geographically closest to the telecommunication terminal;
c) session information is communicated to the telecommunication terminal and the streaming server by the relevant session server;
d) a direct connection is made between the telecommunication terminal and the streaming server of the relevant application, for example a video game;
e) setting up a direct connection between the telecommunication terminal and the relevant streaming server involves the following steps being initiated:
   i. recording of the audio/video data of the running application, for example a game, via the relevant streaming server of the game;
   ii. compression of the audio/video data by high-quality hardware encoders;
   iii. transmission of the compressed audio/video data via WAN;
   iv. reception of the audio/video data on the part of the telecommunication terminal;
   v. decompression of the audio/video data by means of
   vi. reception and reproduction of the audio/video data on the telecommunication terminal (small);
   vii. recording the actions (inputs) of the user of the telecommunication terminal, for example a gamer, on the telecommunication terminal (small);
   viii. efficient transmission of the inputs back to the relevant streaming server of the game, and
   ix. reproduction of the transmitted inputs on the streaming server.

### Way of Achieving the Object Relating to the Use of a Telecommunication Network

According to another embodiment, the present invention discloses the use of a telecommunication network for streaming and reproducing applications (APPs) via a particular telecommunication system, in which one or more streaming servers that can connect to one another by telecommunication execute the relevant application and that connect to the respective telecommunication terminal locally, the relevant telecommunication terminal retrieving the required application from a local server that provides the computer power for rendering and encoding the relevant application.

According to yet another embodiment, the present invention discloses the use of a telecommunication network on non-application-native system environments that differ through either different hardware components or software components, wherein the streaming server undertakes the handling of the different applications and the rendering/encoding of the application and the audio and video signals thereof for the individual applications (frames), the data being transmitted to the respective telecommunication terminal—mobile radio, tablet, laptop, PC, TV—and the transmission being performed by means of a modified h.254 protocol and the WAN being used as a transmission means for audio/video packets by UDP/TCP and the complete computer power being undertaken by the relevant streaming server, wherein the packaged data are decoded only on the telecommunication terminal.

The present invention further discloses the use of a telecommunication network for providing a platform-independent streaming technology that is programmed once and portable to any telecommunication terminals, in which the streaming of the individual applications, for example video games, is effected via a WAN, such that
a) a communication with the session server is performed by means of the telecommunication terminal (small applications);
b) a particular session for a particular final consumer is performed for the streaming server of the relevant application, for example a game, that is geographically closest to the telecommunication terminal;
c) session information is communicated to the telecommunication terminal and the streaming server by the relevant session server;
d) a direct connection is made between the telecommunication terminal and the streaming server of the relevant application, for example a video game;
e) setting up a direct connection between the telecommunication terminal and the relevant streaming server involves the following steps being initiated:
   i. recording of the audio/video data of the running application, for example a game, via the relevant streaming server on which the game runs;
   ii. compression of the audio/video data by high-quality hardware encoders;
   iii. transmission of the compressed audio/video data via WAN;
   iv. reception of the audio/video data on the part of the telecommunication terminal;
   v. decompression of the audio/video data;
   vi. visualization of the audio/video data on the telecommunication terminal (small);
   vii. recording the actions (inputs) of the user of the telecommunication terminal, for example a gamer, on the telecommunication terminal (small);
   viii. efficient transmission of the inputs back to the relevant streaming server of the game, and
   ix. reproduction of the transmitted inputs for applications on the streaming server.

### Further Inventive Refinements

According to an embodiment, in the event of a packet loss during the transmission of data to the telecommunication terminal, for example from a gaming server to the telecommunication terminal, the following steps are performed:
a) recovery strategies are called in order to maintain a smooth gaming experience;
b) the suitable recovery strategy is selected and
c) the recovery request is returned to the relevant streaming server of the application, for example of the game.

Embodiments of the present invention disclose the use of a communication network for the communication with a client (user, terminal) with the following source code:

/***********************AddPortAsynchronisation.java***************

************************Responsible for adding relevant ports to network devices
to make ensure smooth communication, technology targets a technique that can run
independent of network hardware [responsible for activating relevant ports in the
network device (for example router) so as to ensure smooth communication. This
technique allows universal use independently of the network hardware of the user.]

***************************************************************

*********************************/

package org.cloundgaming4u.client.portforwarding;
import java.io.IOException;
import net.sbbi.upnp.messages.UPNPResponseException;
import android.content.Context;
import android.os.AsyncTask;
import android.util.Log;
public class AddPortAsync extends AsyncTask<Void, Void, Void> {
private Context context;
private UPnPPortMapper uPnPPortMapper;
private String externalIP;
private String internalIP;
private int externalPort;
private int internalPort;
public AddPortAsync(Context context,UPnPPortMapper uPnPPortMapper,

String

externalIP, String internalIP,
int externalPort, int internalPort) {
this.context = context;
this.uPnPPortMapper = uPnPPortMapper;
this.externalIP = externalIP;
this.internalIP = internalIP;
this.externalPort = externalPort;
this.internalPort = internalPort;
}
@Override
protected void onPreExecute( ) {
super.onPreExecute( );
if(uPnPPortMapper == null)
uPnPPortMapper = new UPnPPortMapper( );
}
@Override
protected Void doInBackground(Void... params) {
if(uPnPPortMapper != null)
{
try
{
Log.d(“cg4u_log”,“Contacting Router for setting network configurations”);
if(uPnPPortMapper.openRouterPort(externalIP,
externalPort,internalIP,internalPort, “CG4UGames”))
{
Log.d(“cg4u_log”,String.format(“Setting network configurations successful
IP:%s Port:%d”,externalIP,externalPort));
Log.d(“cg4u_log”,String.format(“Setting network configurations successful
IP:%s Port:%d”,internalIP,internalPort));
}
}
catch (IOException e)
{
e.printStackTrace( );
}
catch (UPNPResponseException e)
{
e.printStackTrace( );
}
}
return null;
}
@Override
protected void onPostExecute(Void result) {
super.onPostExecute(result);
//Send broadcast for update in the main activity
//Intent i = new

Intent(ApplicationConstants.APPLICATION_ENCODING_TEXT);

//context.sendBroadcast(i);
}
}
/*******************************UniversalPortMapper.java***********

************************

Responsible for making sure that random port generated by server is

dynamically [responsible for the generic port allocation of the server.]

mapped at
client end
***************************************************************

*********************************/

package org.cloundgaming4u.client.portforwarding;
import net.sbbi.upnp.impls.InternetGatewayDevice;
import net.sbbi.upnp.messages.UPNPResponseException;
import java.io.IOException;
public class UPnPPortMapper {
private InternetGatewayDevice[ ] internetGatewayDevices;
private InternetGatewayDevice foundGatewayDevice;
/**

. Search for IGD External Address
. @return String

*/
public String findExternalIPAddress ( ) throws IOException,

UPNPResponseException {

/** Upnp devices router
search*/
if(internetGatewayDevices == null)
{
internetGatewayDevices =
InternetGatewayDevice.getDevices(ApplicationConstants.SCAN_TIMEOUT);
}
if(internetGatewayDevices != null)
{
for (InternetGatewayDevice IGD : internetGatewayDevices)
{
foundGatewayDevice = IGD;
return IGD.getExternalIPAddress( ).toString( );
}
}
return null;
}
/**

. Search Found Internet Gateway Device Friendly Name
. @ return

*/
public String findRouterName( ){
if(foundGatewayDevice != null){
return
foundGatewayDevice.getIGDRootDevice( ).getFriendlyName( ).toString( );
}
return “null”;
}
/**

. Open Router Port
. IGD == Internet Gateway Device

*

. @param internalIP
. @param internalPort
. @param externalRouterIP
. @param externalRouterPort
. @param description
. @ return
. @throws IOException
. @throws UPNPResponseException

*/
public boolean openRouterPort(String externalRouterIP,int externalRouterPort,
String internalIP,int internalPort,
String description)
throws IOException, UPNPResponseException {
/** Upnp devices router
search*/
if(internetGatewayDevices == null){
internetGatewayDevices =
InternetGatewayDevice.getDevices(ApplicationConstants.SCAN_TIMEOUT);
}
if(internetGatewayDevices != null){
for (InternetGatewayDevice addIGD : internetGatewayDevices) {
/** Open port for TCP protocol and also for UDP protocol

. Both protocols must be open this

is a MUST*/
//addIGD.addPortMapping(description, externalRouterIP, internalPort,
externalRouterPort, internalIP, 0, ApplicationConstants.TCP_PROTOCOL);
addIGD.addPortMapping(description, externalRouterIP, internalPort,
externalRouterPort, internalIP, 0, ApplicationConstants.UDP_PROTOCOL);
}
return true;
}else{
return false;
}
}
public boolean removePort(String externalIP,int port) throws IOException,
UPNPResponseException{
/** Upnp devices router
search*/
if(internetGatewayDevices == null){
internetGatewayDevices = InternetGatewayDevice.getDevices(5000);
}
/**Remote port mapping for all routers*/
if(internetGatewayDevices != null){
for (InternetGatewayDevice removeIGD : internetGatewayDevices) {
// removeIGD.deletePortMapping(externalIP, port,
ApplicationConstants.TCP_PROTOCOL);
removeIGD.deletePortMapping(externalIP, port, “UDP”);
}
return true;
}else{
return false;
}
}
}
***************************************************************

**********************

. End of ClientNetworkCommunication

***************************************************************

**********************

Other embodiments of the present invention are implemented in connection with a telecommunication network according to the invention for the decoding of a video application and for the decoding of a terminal with the following source code:

/***************************************************************

*********************************

*Here is the portion of code responsible for hardware decoding on android end
*hardware decoding enables smooth and rendering on android client side [this

portion of the code is responsible for the hardware decoding of the Android terminal,]

***************************************************************

*********************************/

gbx_builtin_hw_decode_h264(RTSPThreadParam * streamConfigs, unsigned

char *buffer,

int bufsize, struct timeval pts, bool marker) {
struct mini_h264_context ctx;
int more = 0;
// look for sps/pps
again:
if((more = gbx_h264buffer_parser(&ctx, buffer, bufsize)) < 0) {
gbx_stream_error(“%lu.%061u bad h.264 unit.\n”, pts.tv_sec, pts.tv_usec);
return 1;
}
unsigned char *s1;
int len;
if(gbx_contexttype == 7) {
// sps
if(streamConfigs>
videostate == RTSP_VIDEOSTATE_NULL) {
gbx_stream_error(“rtspclient: initial SPS received.\n”);
if(initVideo(streamConfigs>
jnienv, “video/avc”, gbx_contextwidth,
gbx_contextheight) == NULL) {
gbx_stream_error(“rtspclient: initVideo failed.\n”);
streamConfigs>
exitTransport = 1;
return 1;
} else {
gbx_stream_error(“rtspclient: initVideo success
[video/avc@%ux%d]\n”,
gbx_contextwidth, gbx_contextheight);
}
if(gbx_contextrawsps != NULL && gbx_contextspslen > 0) {
videoSetByteBuffer(streamConfigs>
jnienv, “csd0”,
gbx_contextrawsps, gbx_contextspslen);
free(gbx_contextrawsps);
}
streamConfigs>
videostate = RTSP_VIDEOSTATE_SPS_RCVD;
// has more nals?
if(more > 0) {
buffer += more;
bufsize =
more;
goto again;
}
return 1;
}
} else if(gbx_contexttype == 8) {
if(streamConfigs>
videostate == RTSP_VIDEOSTATE_SPS_RCVD) {
gbx_stream_error(“rtspclient: initial PPS received.\n”);
if(gbx_contextrawpps != NULL && gbx_contextppslen > 0) {
videoSetByteBuffer(streamConfigs>
jnienv, “csd1”,
gbx_contextrawpps, gbx_contextppslen);
free(gbx_contextrawpps);
}
if(startVideoDecoder(streamConfigs>
jnienv) == NULL) {
gbx_stream_error(“rtspclient: cannot start video decoder.\n”);
streamConfigs>
exitTransport = 1;
return 1;
} else {
gbx_stream_error(“rtspclient: video decoder started.\n”);
}
streamConfigs>
videostate = RTSP_VIDEOSTATE_PPS_RCVD;
// has more nals?
if(more > 0) {
buffer += more;
bufsize =
more;
goto again;
}
return 1;
}
}
//
if(streamConfigs>
videostate != RTSP_VIDEOSTATE_PPS_RCVD) {
if(android_start_h264(streamConfigs) < 0) {
// drop the frame
gbx_stream_error(“rtspclient: drop video frame, state=%d type=%d\n”,
streamConfigs>
videostate, gbx_contexttype);
}
return 1;
}
if(gbx_contextis_config) {
//gbx_stream_error(“rtspclient: got a config packet, type=%d\n”,
gbx_contexttype);
decodeVideo(streamConfigs>
jnienv, buffer, bufsize, pts, marker,
BUFFER_FLAG_CODEC_CONFIG);
return 1;
}
//
if(gbx_contexttype == 1 ∥ gbx_contexttype == 5 ∥ gbx_contexttype == 19) {
if(gbx_contextframetype == TYPE_I_FRAME ∥ gbx_contextframetype ==
TYPE_SI_FRAME) {
// XXX: enable intrarefresh
at the server will disable IDR/Iframes
// need to do something?
//gbx_stream_error(“got an I/SI frame, type = %d/%d(%d)\n”,
gbx_contexttype, gbx_contextframetype, gbx_contextslicetype);
}
}
decodeVideo(streamConfigs>
jnienv, buffer, bufsize, pts, marker, 0/*marker ?
BUFFER_FLAG_SYNC_FRAME : 0*/);
return 0;
}
***************************************************************

**********************

. End of DecodeVideo

***************************************************************

**********************

According to some embodiments, the following source code is used according to the invention for the dynamic error handling strategies:

#ifndef _{——}UPSTREAM_REQUEST_H_{——}
#define _{——}UPSTREAM_REQUEST_H_{——}
#define PACKET_LOSS_TOLERANCE 0
#define RE_REQUEST_TIMEOUT 30
#define USER_EVENT_MSGTYPE_NULL 0
#define USER_EVENT_MSGTYPE_IFRAME_REQUEST 101
#define USER_EVENT_MSGTYPE_INTRA_REFRESH_REQUEST 102
#define USER_EVENT_MSGTYPE_INVALIDATE_REQUEST 103
#define RECOVER_STRATEGY_NONE 0
#define RECOVER_STRATEGY_REQ_IFRAME_BLOCKING 1
#define RECOVER_STRATEGY_REQ_IFRAME_NON_BLOCKING 2
#define RECOVER_STRATEGY_REQ_INTRA_REFRESH 3
#define RECOVER_STRATEGY_REQ_INVALIDATE 4
//#define SERVER_HW_ENCODER_FIX
// upstream event
#ifdef WIN32
#pragma pack(push, 1)
#endif
struct sdlmsg_upstream_s {
unsigned short msgsize;
unsigned char msgtype; // USER_EVENT_MSGTYPE_*
unsigned char which;
unsigned int pkt; // packet number to be invalidated
struct timeval pst; //timestamp of packet
}
#ifdef WIN32
#pragma pack(pop)
#else
_{——}attribute_{——}((_{——}packed_{——}))
#endif
;
typedef struct sdlmsg_upstream_s sdlmsg_upstream_t;
#endif
***************************************************************

**********************

. End of DynamicErrorHandlingStrategies

***************************************************************

**********************

According to some embodiments, the following source code for a video packet compression:

### BRIEF DESCRIPTION OF THE DRAWINGS

The drawing illustrates the invention—partly schematically—by way of example, and:

FIG. 1 shows a block diagram with a schematic depiction of the relationship between the individual areas and the streaming server;

FIG. 2 shows a block diagram of the game package module;

FIG. 3 shows a block diagram of the session management server;

FIG. 4 shows a block diagram of the mobile—interactive layer for the client;

FIG. 5 shows a block diagram with a flowchart for the recovery module of the client;

FIG. 6 shows the mobile-interactive layer—exemplary visualization of the surface of a mobile terminal;

FIG. 7 shows the recovery strategy process in the event of loss of a data packet.

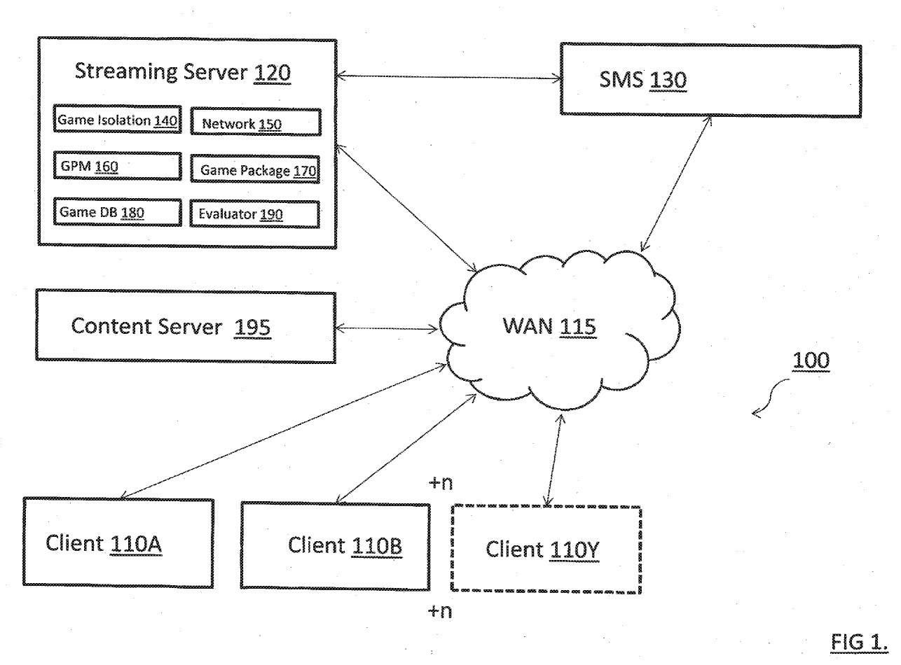

FIG. 1 shows a telecommunication system 100 of according to embodiments of the present invention including the individual elements that are required in the communication performed throughout the system 100. As such, the streaming server 120 undertakes the initialization of the application and has it started in a virtual environment. For this purpose, the streaming server 120 has a game isolation module 140. In the latter, an application-friendly environment is started that first ensures the executability of the application but is also responsible for reproduction of the control signals of the client 110A. The streaming server can start any number of instances of the same or different application(s). The limiting factor in this relationship is the computer power of the GPU for graphical applications. Each started application is allocated a game DB 180. This game DB 180 is responsible for storing relevant data for the application. In order to start an application, however, it first of all needs to be available to the game package module (GPM) 160 as a game package 170. The network module 150 of the streaming server 120 subsequently undertakes the encoding and packaging of the frames. A further task of the network module 150 is the handling of recovery requests of the client 110A. In order to perform administrative interventions and evaluations, the evaluator module 190 has been developed. This module is responsible for producing statistics.

The client 110 (110C, 110B . . . 110Y) serves as a thin client for the transmission of the audio/video signals and can typically be used on any desired platform. A streaming server 120 can enter into a 1:n relationship, but a client 110 can only take up communication with one particular streaming server 120. Typically, the number of clients per streaming server 120 is limited not by the software but rather by the relevant hardware capacities of the GPU of the streaming server 120.

A communication between streaming server 120 and client 110A is always initially set up via the session management server (SMS) 130. The session management server 130 takes the initial request of the client 110A for connecting to the streaming server 120 and looks for the optimum streaming server 120 for the client 110A. Multiple streaming servers 120 may be operating in parallel in a system 100. These also do not always have to be in the same computer center or country. After the allocation of a streaming server 120 by the session management server 130 for the client 110A, the streaming server 120 undertakes the direct communication with the client 110A.

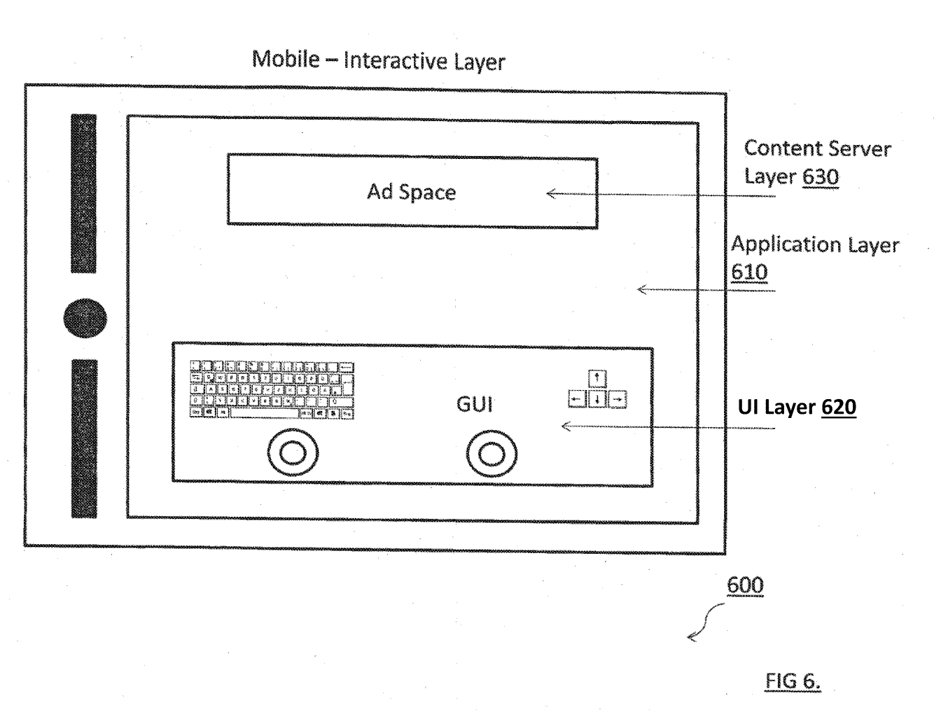

A further element is the content server 195. The content server 195 is responsible for the delivery of particular parts in the interactive layer 600 (as depicted in FIG. 6) of the client 110A. As such, the content server 195 controls, the display of advertising in accordance with the application that is displayed on the client 110A. The necessary information is made available to the content server 195 directly or via the session management server 130.

The communication takes place primarily via the WAN (Wide Area Network) 115. This includes various types of transmission and is not restricted to particular areas.

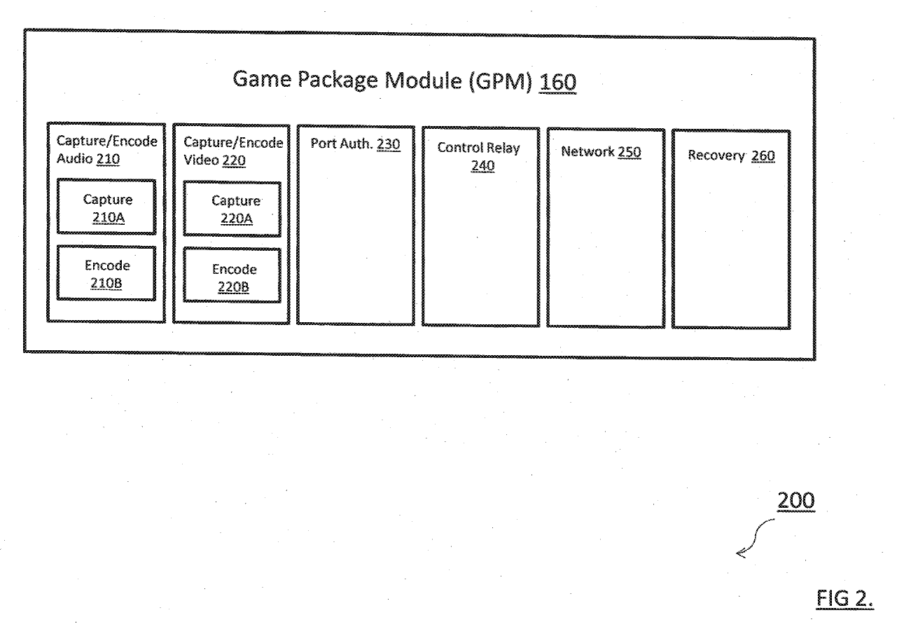

FIG. 2 shows a configuration 200 of the game package module 160, which is part of the streaming server 120 of FIG. 1. The game package module 160 is initially started for every new application and takes on six subareas for the application. Capture encode audio 210 is divided into the areas capture 210A and encode 210B, responsible for tapping off the audio signal. The capture encode video area 220 is divided into the same areas as the audio module 210. The port authentication module 230 undertakes port authentication and is equivalent to providing the connection between game stream server 120 and the client 110A. A control relay 240 is responsible for facilitating the connection. The task of the network relay 250 is to send the applicable packets and manage arriving packets. The recovery module 260 is responsible for responding to the applicable recovery requests of the client 110A.

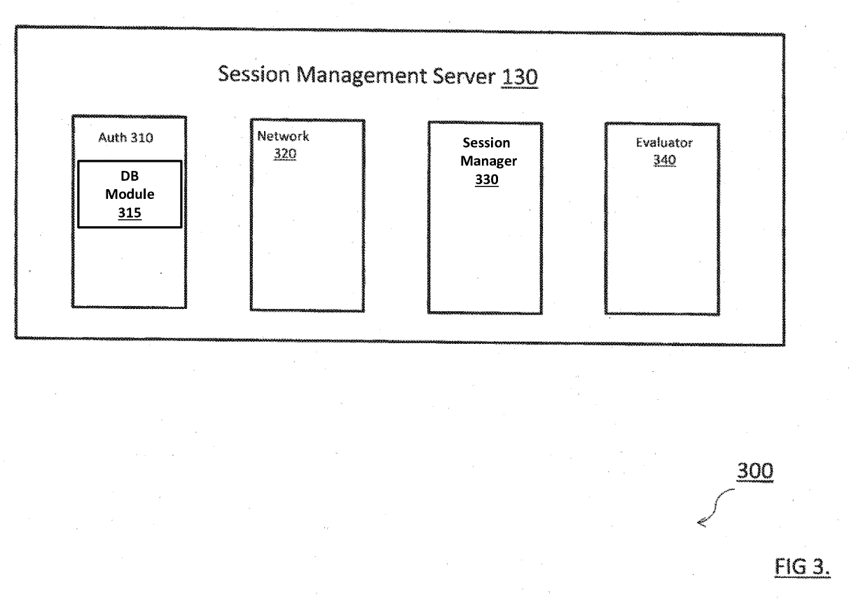

FIG. 3 is a configuration 300 of the session management server 130. The session management server 130 has the task of authentication 310 and, using a downstream DB module 315, the task thereof of storing or depositing the data used for authentication. This DB module 315 is only optional, however. The possibility of external authentication is unaffected thereby. The network 320 area is responsible for the communication between WAN 115, streaming server 120, content server 195 and the applicable clients 110. The session manager 330 is then critically responsible for managing the individual sessions and undertakes the allocation of the clients 110 to an applicable streaming server 120. The evaluator module 340 has a direct connection to the individual clients 110 and collects relevant data for a later central evaluation.

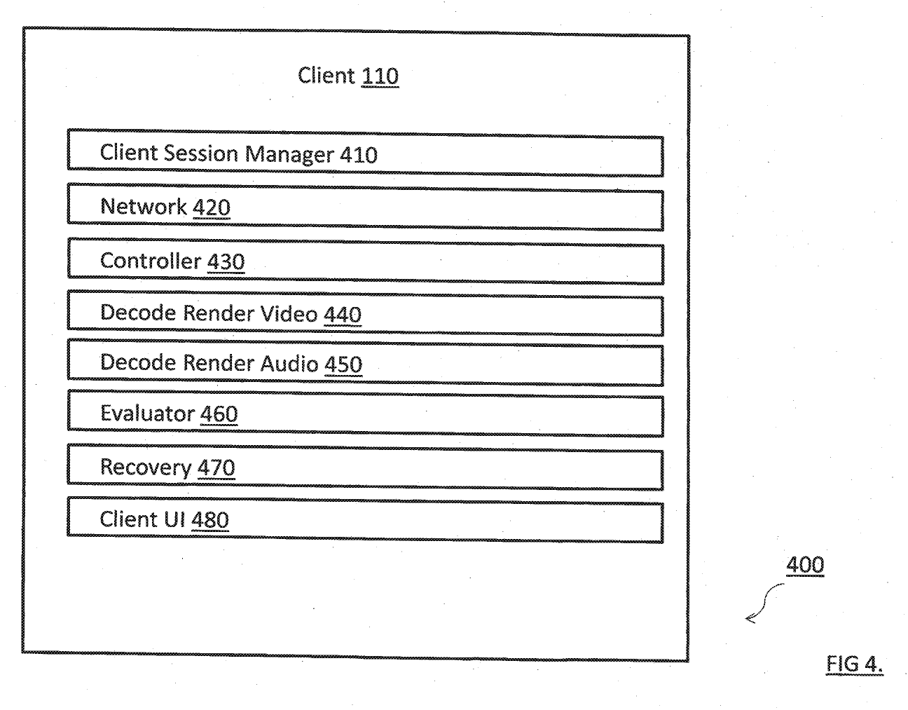

FIG. 4 shows a configuration 400 of the individual elements of the client 110. The client 110 has been developed specifically for the application and requires no separate software. It consists of eight areas that are described as follows.

Client session manager 410, communicates with the streaming server 120 and session management server 130 and is initially responsible for the authentication and management of the client 110.

Network module 420 is responsible for setting up the connection and maintaining it. This module 420 also undertakes the sending and receiving of various packets.

The controller 430 undertakes delivery of the supplied frames and audio packets as a visual image in the client 110.

Decode render video 440 and decode render audio 450 receive the packets that have previously been received from the network module 420 and have been forwarded by the controller 430.

The evaluator module 460 is responsible for collecting statistical data and transmits said data to the session management server 130. Accordingly, the session management server 130 can also optimize the connection. A feedback loop is thus produced, which makes this module 460 very important.

The recovery module 470 rates arriving data packets. Should a data packet be erroneous, the recovery module 470 chooses a recovery strategy and if need be requests a new packet from the streaming server 120 or undertakes other measures in order to compensate for the loss without arriving at a loss in latency or quality.

The client UI 480 contains the interactive layer 600 (as depicted in FIG. 6) and content of the content server 195. There, the input of the user is intercepted and sent to the streaming server 120.

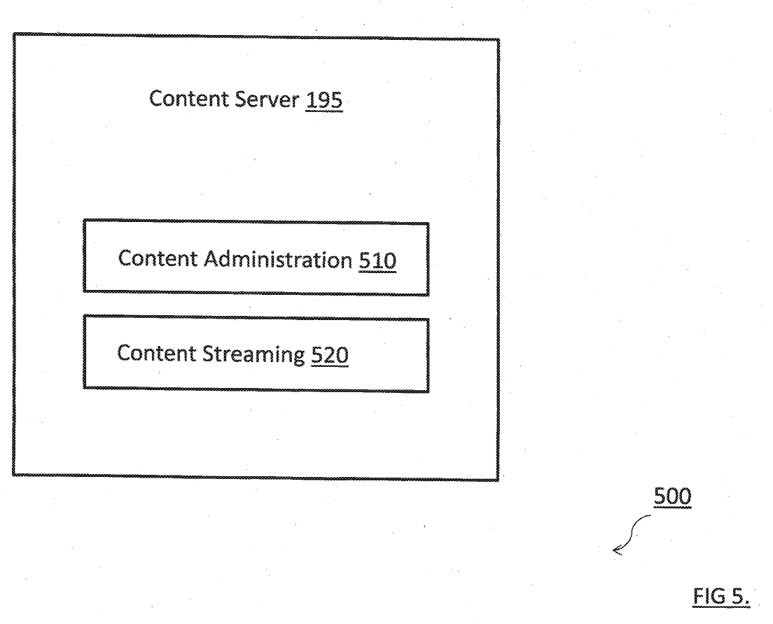

FIG. 5 shows the design 500 of the content server 195. Said content server 195 is responsible for the content administration 510 and content streaming 520.

The content administration 510 is used for presetting the advertising, e.g. that is to be displayed, within the interactive layer 600 in the client 110. The content administration 510 is intended to be used to stipulate both the frequency and the content.

The content streaming module 520 undertakes the display of the content and serves as a central interface for all clients 110.

FIG. 6 depicts the mobile-interactive layer 600, which is part of the client UI 480. Fundamentally, a distinction is drawn between three different areas.

The application layer 610 reproduces the received frames and is responsible for the visual depiction of the application.

Above the application layer 610, there is the UI layer 620. This layer can be configured individually but is fundamentally definitively responsible for the input of the user in the client 110.

Besides the two aforementioned layers, there is the possibility of loading content from the content server 195. This then takes place in the area of the content server layer 630.

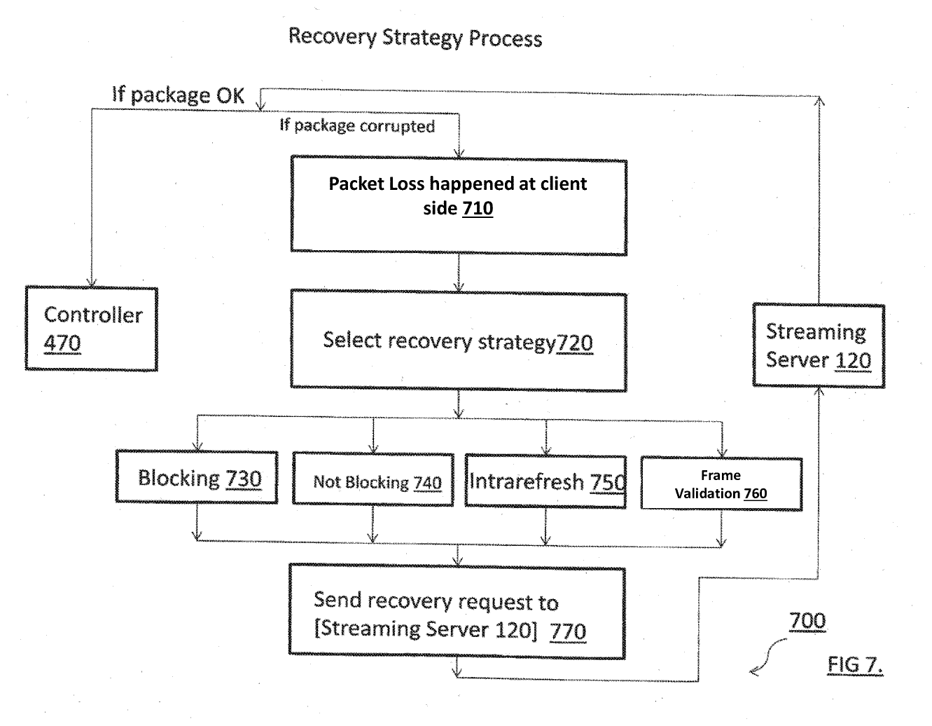

FIG. 7 shows the sequence of the recovery strategy process 700 of the client 110 in the recovery module 470. As soon as a “package loss” has been detected at 710 on the part of the client 110, the recovery module 470 will select at 720 an appropriate solution on the basis of firmly defined criteria.

Once the decision has been made concerning whether blocking at 730, not blocking at 740, intrarefresh at 750 or frame validation at 760 has been chosen, the recovery request 770 is sent to the streaming server 120. The streaming server 120 accordingly sends a new packet and the task of the recovery module 470 has been performed.

The features described in the patent claims and in the description and evident from the drawing can be essential to realizing the invention either individually or in any combinations.

What is claimed is:

1. A system comprising:
one or more streaming servers, each server including a processor for (i) streaming applications via a communications network, (ii) processing frames associated with the streamed applications, and (iii) handling recovery requests associated with the processed frames;
a client terminal configured for direct communication with an optimum one of the one or more streaming servers of at least one of the streamed applications via the network, the communication including collecting statistical data relevant to packets of the at least one application; and
a session management server for receiving the collected statistical data and identifying the optimum one of the one or more streaming servers for direct communication with the client terminal, the identifying being based on the received statistical data;
wherein a feedback loop is formed between the session management server and the client terminal to optimize the communication therebetween; and
wherein the client terminal is configured to activate a packet recovery strategy based on packet loss and the feedback loop.

2. A method for streaming and reproducing applications via a system including one or more streaming servers, each server including a processor for (i) streaming applications via a communications network, (ii) processing frames associated with the streamed applications, and (iii) handling recovery requests associated with the processed frames, the method comprising:
directly communicating, via a client terminal, with an optimum one of the one or more streaming servers of at least one of the streamed applications via the network, the communication including collecting statistical data relevant to packets of the at least one application;
receiving, a session management server, the collected statistical data and identifying the optimum one of the one or more streaming servers for direct communication with the client terminal, the identifying being based on the received statistical data;
wherein a feedback loop is formed between the session management server and the client to optimize the communication therebetween; and
wherein the client terminal is configured to activate a packet recovery strategy based on packet loss and the feedback loop.

3. A method for reproducing applications on non-application-native system environments that differ through either different hardware components or software components, the method comprising:
connecting a sessions management server to a client terminal via a telecommunication network to authenticate client requests for the one or more streaming servers;
establishing, via the sessions management server, a direct connection locally between the client terminal and a streaming server of the one or more streaming server running a relevant application as selected by the sessions management server based on a client request; and
sourcing computer power, via the streaming server for handling of different applications associated with running the relevant application and rendering/encoding of the relevant application and audio and video signals thereof,
wherein data associated with the audio and video signals are transmitted via the telecommunication network directly to the client terminal for decoding only, and wherein the telecommunication network is a Wide Area Network(WAN) for transmitting the audio and video signals in audio/video packets by UDP/TCP.

4. The method of claim 1, wherein the recovery strategy further comprises:
selecting, via a recovery module of the client terminal a suitable recovery strategy; and
sending a recovery request to the streaming server of the relevant application directly from the recovery module of the at least one client terminal, for receiving a new packet.

5. A computer readable media storing instructions, wherein said instructions, when executed are configured to execute a process within a computer system with a method for reproducing applications on non-application-native system environments that differ through either different hardware components or software components, the method comprising:
connecting a sessions management server to a client terminal via a telecommunication network to authenticate client requests for the one or more streaming servers;
establishing, via the sessions management server, a direct connection locally between the client terminal and a streaming server of the one or more streaming server running a relevant application as selected by the sessions management server based on a client request; and
sourcing computer power, via the streaming server for handling of different applications associated with running the relevant application and rendering/encoding of the relevant application and audio and video signals thereof,
wherein data associated with the audio and video signals are transmitted via the telecommunication network directly to the client terminal for decoding only, and wherein the telecommunication network is a Wide Area Network (WAN) for transmitting the audio and video signals in audio/video packets by UDP/TCP.
